(19) United States
(12) Patent Application Publication
(10) Pub. No.: US 2002/0171309 A1
(43) Pub. Date: Nov. 21, 2002

(54) Rotor and rotating electrical machine with embedded permanent magnet

(76) Inventors: Shinichi Wakui, Hitachi (JP); Haruo Koharagi, Juo (JP); Ryoichi Takahata, Hitachi (JP); Takashi Seshimo, Oohira (JP); Hiroshi Hirayama, Oyama (JP); Miyoshi Takahashi, Hitachi (JP)

Correspondence Address: DICKSTEIN SHAPIRO MORIN & OSHINSKY LLP, 2101 L STREET NW, WASHINGTON, DC, 20037-1526, US

(21) Appl. No.: 09/963,414

(22) Filed: Sep. 27, 2001

(30) Foreign Application Priority Data
May 21, 2001 (JP) 2001-150766

(51) Int. Cl. H02K 21/12

(52) U.S. Cl. 310/156.48; 310/156.57

(57) ABSTRACT

Reduction of cogging torque and torque pulsation in the rotor with permanent magnets embedded therein. In a rotating electrical machine comprising a stator 5 with an armature winding wound on the stator core and a rotor 1 with permanent magnet 2 embedded in the rotor core 9, a magnetic flux short circuit preventive hole 3 radially extending from the circumferential ends of the permanent magnets 2 (in the vicinity of q-axis) to the vicinity of outer periphery of the rotor core is further extended toward the d-axis (circumferential direction). At the same time, the distance between the outer periphery of the magnetic flux short circuit preventive hole 3 and that of the rotor core is increased gradually in conformity to the approach to d-axis side from q-axis.

### BACKGROUND OF THE INVENTION

1. Field of the Invention

The present invention relates to the permanent magnet type rotating electrical machine having a rotor with permanent magnets embedded in the core.

2. Prior Art

The magnet embedded type rotor has permanent magnets embedded in the rotor core, so magnetic flux produced by permanent magnets tends to short-circuit between adjacent permanent magnets. So when permanent magnets of flat plates are embedded in the rotor core, for example, short circuit preventive holes (voids) extending from the ends of permanent magnets to the vicinity of outer periphery of the rotor core are provided to prevent magnetic flux from being short-circuited, according to the Japanese Application Patent Laid-Open Publication No. Hei 11-98731.

Further, to reduce cogging torque and torque pulsation, the circumferential width of the magnetic flux short circuit preventive hole is defined. According to the Japanese Application Patent Laid-Open Publication No. Hei 2000-50546, the void is bent toward the center of the permanent magnet to improve the main magnetic flux torque.

In the prior arts described above, the circumferential width of magnetic flux short circuit preventive hole is defined (30 degrees from interpolar position in terms of electric angle) to reduce cogging torque and torque pulsation.

However, to achieve a considerable reduction in cogging torque and torque pulsation, it is necessary to minimize the harmonic wave component of magnetic flux distribution (magnetic flux density distribution of air gap) from the rotor to the stator, and a sufficient effect cannot be obtained from only the circumferential width of the magnetic flux short circuit preventive hole.

### SUMMARY OF THE INVENTION

The object of the present invention is to provide a permanent magnet type rotating electrical machine capable of reducing cogging torque and torque pulsation, hence vibration and noise.

To achieve the aforementioned object described according to the present invention, permanent magnets are embedded in the rotor core, and magnetic flux short circuit preventive holes extending from the circumferential ends to the vicinity of outer periphery of the core are provided, and the magnetic flux short circuit preventive hole is formed in such a way that the radial distance between the outer periphery of the magnetic flux short circuit preventive hole and that of the rotor core is increased gradually in conformity to the approach to the pole from the interpolar position.

Furthermore, an angle with respect to the rotor center formed between the ends of two adjacent magnetic flux short circuit preventive holes on the d-axis side is smaller than the angle formed by the permanent magnet with respect to the rotor center.

Further, the magnetic flux short circuit preventive hole is formed in such a way that its radial width of the magnetic flux short circuit preventive hole is decreased gradually in conformity to the approach to the interpolar position to the pole.

The aforementioned arrangement allows the harmonic wave component of the magnetic flux density distribution of air gap to be reduced, with the result that cogging torque and torque pulsation, hence, vibration and noise are reduced.

### BRIEF DESCRIPTION OF THE DRAWINGS

FIG. 1 is a cross sectional view representing the structure of a permanent magnet type rotating electrical machine as one embodiment of the present invention;

FIG. 2 is a cross sectional view representing the structure of a permanent magnet type rotating electrical machine according to the prior art;

FIG. 3 is a graph representing the calculated value of cogging torque, torque pulsation and mean torque according to the present invention;

FIG. 4 is a cross sectional view representing the structure of a permanent magnet type rotating electrical machine as one variation of the embodiment in FIG. 1;

FIG. 5 is a cross sectional view representing the structure of a permanent magnet type rotating electrical machine as another embodiment (concave magnet) of the present invention;

FIG. 6 is a cross sectional view representing the structure of a permanent magnet type rotating electrical machine as still another embodiment (V-shaped magnet) of the present invention;

FIG. 7 is a cross sectional view representing the structure of a permanent magnet type rotating electrical machine as a further embodiment (V-shaped magnet) of the present invention;

FIG. 8 is a cross sectional view representing the structure of a permanent magnet type rotating electrical machine as still further embodiment (concave magnet) of the present invention; and

FIG. 9 is a cross sectional view representing the structure of a permanent magnet type rotating electrical machine as one variation of the embodiment in FIG. 8.

### DETAILED DESCRIPTION OF THE INVENTION

The following gives a detailed description of the embodiments of the present invention with reference to the drawings:

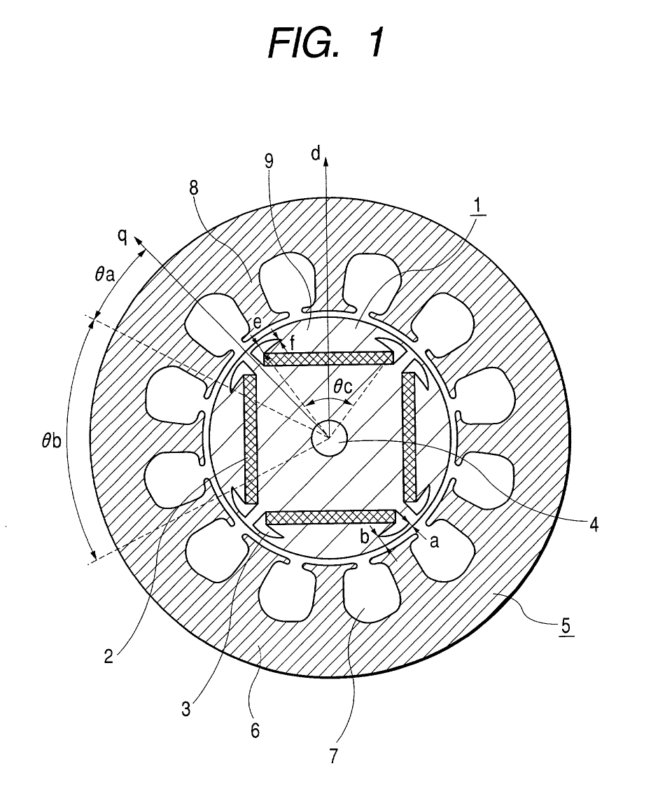

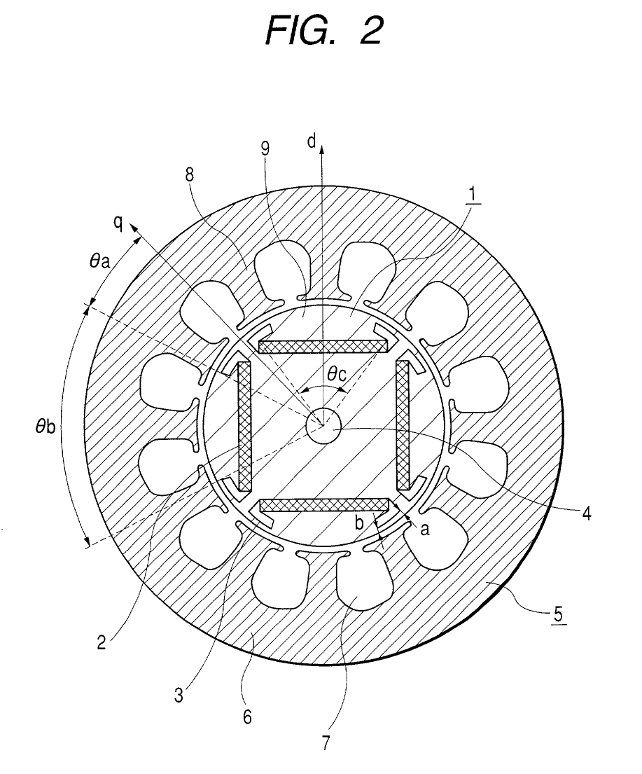

FIG. 1 is a drawing representing the permanent magnet type rotating electrical machine with embedded magnets as one embodiment of the present invention. FIG. 2 is a drawing representing the prior art configuration of a permanent magnet type rotating electrical machine with embedded magnets. In the drawing, a 4-pole apparatus is shown, however, the number of the poles are not restricted.

As shown in FIG. 2, the rotating electrical machine consists of a stator 5 and a rotor 1. On the stator 5, multiple tees 8 are connected by core backs 6, and armature winding (not illustrated) is provided in the slot 7. On the rotor 1, permanent magnet installation holes are formed on the rotor core 9, and four permanent magnets 2 of flat plates are embedded in these holes.

The permanent magnets 2 of flat plates are characterized by easy production, low production cost and excellent dimensional accuracy. Further, the gap between permanent magnets 2 and permanent magnet insertion holes can be reduced.

Assume that d-axis is defined as the axis extending in the center direction of the magnetic pole of the rotor 1, and q-axis is defined as the axis extending in the interpolar direction 90 degrees deviated from the center direction of the magnetic pole in terms of electric angle.

Magnetic flux short circuit preventive holes (voids) 3 radially extending from the circumferential end (in the vicinity of q-axis) of the permanent magnet 2 to the vicinity of the outer periphery of the rotor core are formed.

The magnetic flux short circuit preventive holes 3 are further made to extend to the sd-axis side (circumferential) in such a way that angle θb formed with respect to rotor center by the ends on the d-axis side for adjacent magnetic flux short circuit preventive holes 3 is smaller than angle θc formed by the outer periphery of the permanent magnet 2 with respect to rotor center. This allows the magnetic flux of the permanent magnet 2 to be concentrated on the d-axis side.

As explained above, the distance between the outer periphery of magnetic flux short circuit preventive hole 3 and the outer periphery of the rotor core and the outer periphery of the rotor core (“a” and “b”) is minimized in order to minimize possible short circuiting caused between magnetic flux produced from the permanent magnet 2 and its adjacent magnet.

However, such formation of magnetic flux short circuit preventive holes 3 will cause the magnetic flux from the rotor 1 to stator 5 to be concentrated on the area of angle θb, and the amount of the magnetic flux from rotor 1 to stator 5 will be much decreased in the area of angle θa. In other words, magnetic flux density distribution of air gap will be distorted by that amount.

In the of the present invention shown in FIG. 1, the structure of the stator 5 is the same as that of the prior art, but the magnetic flux short circuit preventive holes 3 of the rotor 1 are different.

According to the present invention, magnetic flux short circuit preventive holes 3 extending from the circumferential end (in the vicinity of q-axis) of the permanent magnet 2 to the vicinity of the outer periphery of the rotor core are made to extend further toward the d-axis (circumferential direction).

At the same time, the outer periphery of the magnetic flux short circuit preventive holes 3 is formed in an arch shaped to ensure that the distance between the outer periphery of the magnetic flux short circuit preventive hole 3 and that of the rotor core is increased gradually in conformity to the approach to d-axis side from q-axis.

In other words, arrangement is made to ensure the relationship of b>a where the distance between the outer periphery of the magnetic flux short circuit preventive hole 3 and that of the rotor core is increased gradually in conformity to the approach to d-axis side from q-axis is “d” close to the d-axis and “b” closest to the q-axis.

When the radial distance between the outer periphery of the magnetic flux short circuit preventive hole 3 and that of the rotor core is defined as explained above, the amount of the magnetic flux from rotor 1 to stator 5 is decreased in the area of angle θa in conformity to the approach to q-axis side from d-axis, with the result that magnetic flux density distribution will come closer to sinusoidal wave distribution. This can reduce the cogging torque and torque pulsation, hence, vibration and noise.

Furthermore, if the radial length of magnetic flux short circuit preventive holes 3 is made smaller gradually in conformity to the approach to q-axis side from q-axis (e>f) within the area of the angle θc formed by the outer periphery of the permanent magnet 2 with respect to rotor center, then air gap is gradually increased in conformity to the approach to q-axis side from d-axis in the area of angle θa. So magnetic flux density distribution comes closer to sinusoidal wave distribution, resulting in reduction of cogging torque and torque pulsation; hence, vibration and noise.

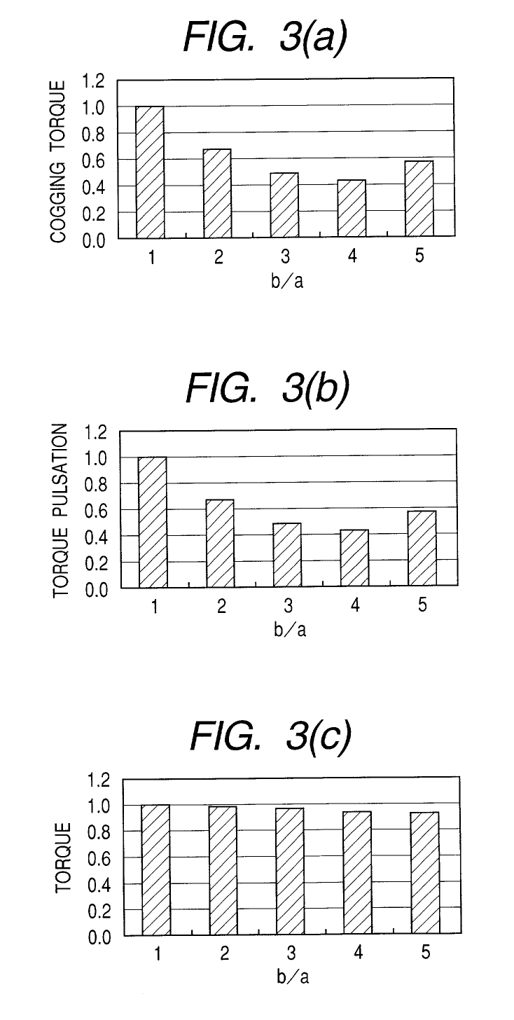

FIG. 3 shows an example of calculating the relationship of b/a with respect to cogging torque, torque pulsation, and average torque when the θa and “a” is kept constant.

FIG. 3(a) shows the result of cogging torque. Here the maximum value of cogging torque in b/a=1 is defined as “1”. As illustrated, the value is the minimum when b/a=4. Cogging torque can be reduced down to about 40% of the value at b/a=1.

FIG. 3(b) shows torque pulsation under load. The maximum value of torque pulsation for b/a=1 is defined as “1”. Similarly to the result of cogging torque, the value is the minimum when b/a=4. Cogging torque can be reduced down to about 40% of the value at b/a=1.

FIG. 3(c) shows the result of calculating the mean torque. The value of the mean torque for b/a=1 is defined as “1”. Here the mean torque signifies the torque valid for motor drive. As illustrated, increase of b/a means a greater possibility of magnetic flux leakage, but the decrease is very small. Comparison of b/a=1 and b/a=4 shows that reduction is only about 4%.

Accordingly, if “a” (the lower limit for the value “a” corresponds to about 0.35 to 0.5 mm in terms of the thickness of the laminated layer of the rotor core) is minimized to prevent the magnetic flux of the permanent magnet 2 from being short circuited, reduction of the mean torque is very small even when b>a.

A substantial reduction in cogging torque and torque pulsation can be achieved by using the relationship of b>a. Especially when the ratio of “b” to “a” is 4 to 1 or 3 to 1, a considerable effect can be obtained. A substantial reduction of vibration and noise can be achieved with almost no reduction in the output of the rotor.

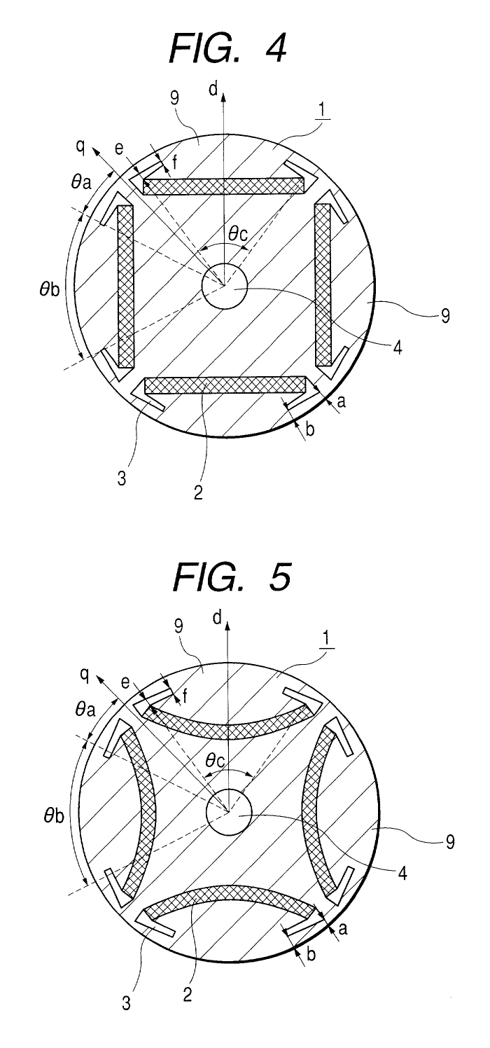

FIG. 4 shows a rotor of the permanent magnet type rotating electrical machine with embedded magnets as a variation of FIG. 1. The following embodiment describes only the rotor. The arrangement of the stator is not described since it is the same as that in FIG. 1.

Rotor 1 has permanent magnet installation holes formed on the rotor core 9, and four permanent magnets 2 of flat plate are embedded therein. In order to prevent the magnetic flux of permanent magnet 2 from short-circuiting with the adjacent permanent magnet, magnetic flux short circuit preventive holes 3 radially extending from the circumferential ends (in the vicinity of q-axis) of permanent magnet 2 to the vicinity of the outer periphery of the rotor core are provided.

Then magnetic flux short circuit preventive holes 3 are further extended to the d-axis side (circumferential), thereby causing the magnetic flux of permanent magnet 2 to be concentrated on the d-axis side. At the same time, arrangement is made to ensure that the distance between the outer periphery of the magnetic flux short circuit preventive hole 3 and that of the rotor core is increased gradually in conformity to the approach to d-axis side from q-axis.

Here the outer periphery of the magnetic flux short circuit preventive holes 3 is formed by a straight line. Since the relationship of b>a does not change, the amount of the magnetic flux from rotor 1 to stator 5 is gradually decreased in the area of angle θa in conformity to the approach to q-axis side from d-axis, with the result that magnetic flux density distribution comes close to sinusoidal wave distribution. This makes it possible to reduce cogging torque and torque pulsation; hence, vibration and noise.

FIG. 5 shows a permanent magnet type rotating electrical machine with embedded magnets as another embodiment of the present invention. The rotor 1 has the concave arch-shaped permanent magnet 2 embedded in the rotor core 9 with respect to rotor outer peripheral side. When the permanent magnet 2 is arranged in this form, the surface area of permanent magnet 2 can be made larger than that of FIG. 1, so the mean torque can be increased.

In the shape of the magnet described above, magnetic flux short circuit preventive hole 3 radially extending from the circumferential ends of the permanent magnets 2 (in the vicinity of q-axis) to the vicinity of outer periphery of the rotor core are provided.

Magnetic flux short circuit preventive holes 3 are further extended toward the d-axis (circumferential direction) in such a way that the magnetic flux of permanent magnet 2 is concentrated on the d-axis side. At the same time, the distance between the outer periphery of the magnetic flux short circuit preventive hole 3 and that of the rotor core is increased gradually in conformity to the approach to d-axis side from q-axis.

Accordingly, the amount of the magnetic flux from rotor 1 to stator 5 is decreased in the area of angle θa in conformity to the approach to q-axis side from d-axis, with the result that magnetic flux density distribution comes closer to sinusoidal wave distribution. This can reduce the cogging torque and torque pulsation, hence, vibration and noise.

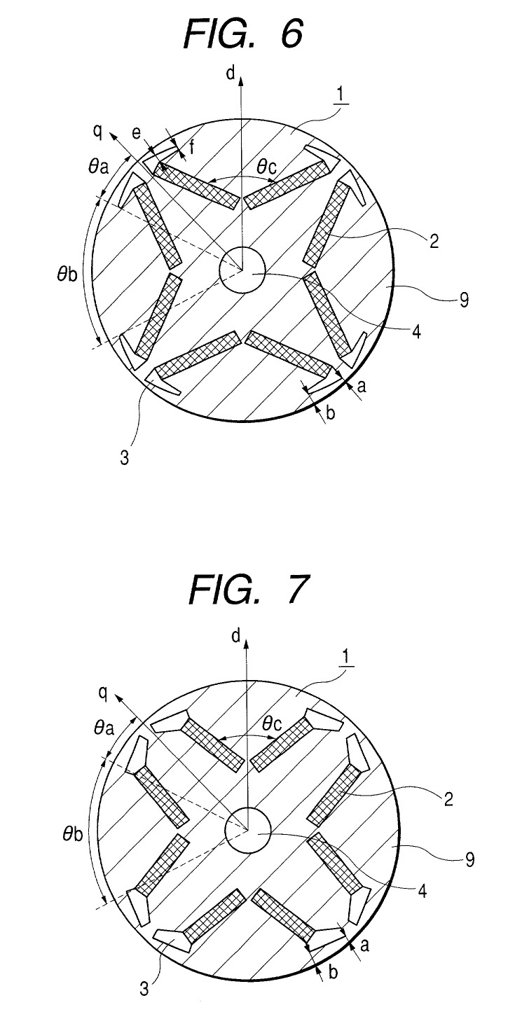

FIG. 6 shows the rotor of a permanent magnet type rotating electrical machine with embedded magnets as still another embodiment according to the present invention.

The rotor 1 has two magnets 2 of flat plate for each pole embedded in the rotor core 9 in a V shape. Since permanent magnets 2 are flat, this arrangement brings about such advantages as easy production, low production cost, a reduced clearance between the permanent magnet 2 and permanent magnet insertion hole, and greater surface area of the permanent magnet than that of FIG. 1.

In this magnet arrangement, magnetic flux short circuit preventive holes 3 radially extending from the circumferential ends of the permanent magnets 2 (in the vicinity of q-axis) to the vicinity of outer periphery of the rotor core are provided.

Magnetic flux short circuit preventive holes 3 are further extended toward the d-axis (circumferential direction) in such a way that the magnetic flux of permanent magnet 2 is concentrated on the d-axis side. At the same time, the distance between the outer periphery of the magnetic flux short circuit preventive hole 3 and that of the rotor core is increased gradually in conformity to the approach to d-axis side from q-axis. This arrangement provides the same effect as described with reference to FIG. 1.

FIG. 7 shows the rotor of a permanent magnet type rotating electrical machine with embedded magnets as a further embodiment according to the present invention.

Similarly to FIG. 6, the rotor 1 has two magnets 2 of flat plate for each pole embedded in the rotor core 9 in a V shape. If the angle θc between two magnets 2 of flat plate constituting each pole is small, however, magnetic flux short circuit preventive holes 3 radially extending from the circumferential ends of the permanent magnets 2 (in the vicinity of q-axis) to the vicinity of outer periphery of the rotor core are provided.

Magnetic flux short circuit preventive holes 3 are further extended toward the d-axis (circumferential direction). At the same time, the distance between the outer periphery of the magnetic flux short circuit preventive hole 3 and that of the rotor core is decreased gradually in conformity to the approach to q-axis side from d-axis. This arrangement provides the same effect as described with reference to FIG. 1.

Here the permanent magnet 2 is arranged in a V shape. If the angle θc formed by the outer periphery of the magnet 2 with respect to rotor center is small, the magnetic flux short circuit preventive holes 3 is extended toward the q-axis (circumferential direction), independently of the arrangement and configuration of the permanent magnet 2. At the same time, the distance between the outer periphery of the magnetic flux short circuit preventive hole 3 and that of the rotor core is decreased gradually in conformity to the approach to q-axis side from d-axis.

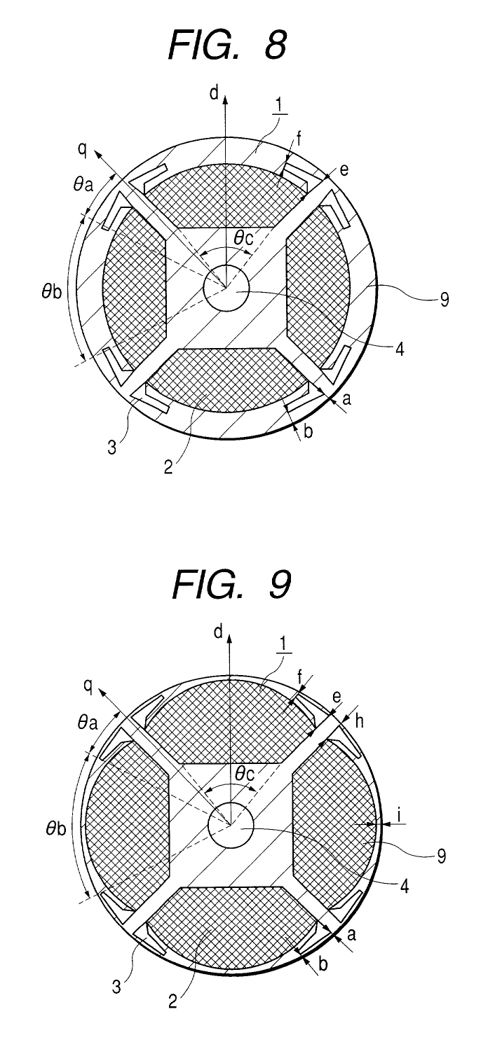

FIG. 8 shows the rotor of a permanent magnet type rotating electrical machine with embedded magnets as a still further embodiment according to the present invention.

The rotor 1 has convex arch-shaped permanent magnet 2 embedded in the rotor core 9 with respect to the outer periphery of the rotor. When the permanent magnet 2 is arranged in this form, the surface area of permanent magnet 2 can be made larger than that of FIG. 1, so the mean torque can be increased. When the permanent magnet 2 is arranged in this form, the surface area of permanent magnet 2 can be increased, so the mean torque can be increased.

In this magnet arrangement, magnetic flux short circuit preventive holes 3 radially extending from the circumferential ends of the permanent magnets 2 (in the vicinity of q-axis) to the vicinity of outer periphery of the rotor core are provided.

Magnetic flux short circuit preventive holes 3 are further extended toward the d-axis (circumferential direction) in such a way that the magnetic flux of permanent magnet 2 is concentrated on the d-axis side. At the same time, the distance between the outer periphery of the magnetic flux short circuit preventive hole 3 and that of the rotor core is increased gradually in conformity to the approach to d-axis side from q-axis. This arrangement provides the same effect as described with reference to FIG. 1.

FIG. 9 is a variation of FIG. 8. In the area of angle θb, the distance between the outer periphery of the permanent magnet and that of the rotor core is increased gradually in conformity to the approach to q-axis side from d-axis (i<h), with the result that magnetic flux density distribution comes closer to sinusoidal wave distribution. This makes it possible to reduce cogging torque and torque pulsation; hence, vibration and noise.

In the present invention shown in FIGS. 4 to 9, the radial length of magnetic flux short circuit preventive holes 3 is made smaller gradually in conformity to the approach to q-axis side from q-axis (e>f) within the area of the angle θc formed by the outer periphery of the permanent magnet 2 with respect to rotor center, as in the case of FIG. 1.

Then air gap is gradually increased in conformity to the approach to q-axis side from d-axis in the area of angle θa. So magnetic flux density distribution comes closer to sinusoidal wave distribution, resulting in reduction of cogging torque and torque pulsation; hence, vibration and noise.

In the present invention, it goes without saying that a non-magnetic substance can be embedded in all or some of magnetic flux short circuit preventive holes 3. When rare earth magnets are used as permanent magnets 2 embedded in the rotor 1, the rotating electrical machine can be downsized since a rare earth magnet has a greater flux density than a ferritic magnet.

According to the present invention, the magnetic flux from the rotor to the stator comes closer to the sinusoidal wave distribution. This makes it possible to reduce cogging torque and torque pulsation; hence, vibration and noise.

What is claimed is:

1. A rotor in a rotating electrical machine comprising; permanent magnets embedded in the rotor core, and
magnetic flux short circuit preventive holes extending from the circumferential ends of said permanent magnets constituting magnetic poles to the vicinity of outer periphery of said rotor core;
said rotor being a rotor with embedded permanent magnets further characterized in that,
when the axis extending in the center direction of the magnetic pole of said rotor is assumed as d-axis, and the axis extending in the interpolar direction 90 degrees deviated from the center direction of said magnetic pole in terms of electric angle is assumed as q-axis,
the radial distance between the outer periphery of said magnetic flux short circuit preventive hole and that of said rotor core is increased gradually in conformity to the approach to d-axis side from q-axis.

2. A rotor in a rotating electrical machine comprising; permanent magnets embedded in the rotor core, and
magnetic flux short circuit preventive holes extending from the circumferential ends of said permanent magnets constituting magnetic poles to the vicinity of outer periphery of said rotor core;
said rotor being a rotor with embedded permanent magnets further characterized in that,
when the axis extending in the center direction of the magnetic pole of said rotor is assumed as d-axis, and the axis extending in the interpolar direction 90 degrees deviated from the center direction of said magnetic pole in terms of electric angle is assumed as q-axis,
an angle with respect to the rotor center formed between the ends of two adjacent magnetic flux short circuit preventive holes on the d-axis side is smaller than the angle formed by the outer periphery of said permanent magnet with respect to the rotor center, and
the radial distance between the outer periphery of said magnetic flux short circuit preventive hole and that of said rotor core is increased gradually in conformity to the approach to d-axis side from q-axis.

3. A rotor with embedded permanent magnets according to claim 1 or 2 characterized in that the radial length of said magnetic flux short circuit preventive holes is decreased gradually in conformity to the approach to d-axis side from q-axis.

4. A rotor with embedded permanent magnets according to any one of claims 1 to 3 characterized in that, when the radial distance between the outer periphery of said magnetic flux short circuit preventive holes and that of said rotor core is assumed as “a” closer to the q-axis, and “b” closer to the d-axis, the ratio of “a” to “b” is about 1 to 3 or 1 to 4.

5. A rotor with embedded permanent magnets according to any one of claims 1 to 4 characterized in that the permanent magnet embedded in said rotor core is a flat plate magnet.

6. A rotor with embedded permanent magnets according to any one of claims 1 to 4 characterized in that the permanent magnet embedded in said rotor core is designed in a concave arch-shaped form with respect to the outer periphery of the rotor.

7. A rotor with embedded permanent magnets according to any one of claims 1 to 4 characterized in that the permanent magnet embedded in said rotor core is designed in a convex arch-shaped form with respect to the outer periphery of the rotor.

8. A rotor with embedded permanent magnets according to any one of claims 1 to 4 characterized in that the permanent magnet embedded in said rotor core is designed in a V shape in each magnetic pole.

9. A rotor with embedded permanent magnets according to any one of claims 1 to 8 characterized in that a non-magnetic substance is inserted in said magnetic flux short circuit preventive hole.

10. A rotating electrical machine equipped with a rotor comprising;
permanent magnets embedded in the rotor core, and
magnetic flux short circuit preventive holes extending from the circumferential ends of said permanent magnets constituting magnetic poles to the vicinity of outer periphery of said rotor core;
said rotating electrical machine further characterized in that said magnetic flux short circuit preventive hole is formed in such a way that the radial distance between the outer periphery of said magnetic flux short circuit preventive hole and that of said rotor core is increased gradually in conformity to the approach to the pole from interpolar position.

11. A rotating electrical machine equipped with a rotor comprising;
permanent magnets embedded in the rotor core, and
magnetic flux short circuit preventive holes extending from the circumferential ends of said permanent magnets constituting magnetic poles to the vicinity of outer periphery of said rotor core;
said rotating electrical machine further characterized in that said magnetic flux short circuit preventive hole is formed in such a way that the radial distance between the outer periphery of said magnetic flux short circuit preventive hole and that of said rotor core is increased gradually in conformity to the approach to the pole from interpolar position; and
an angle with respect to the rotor center formed between the ends of two adjacent magnetic flux short circuit preventive holes on the interpolar side is smaller than the angle formed by the outer periphery of said permanent magnet with respect to the rotor center.
